(19) United States
(12) Patent Application Publication
(10) Pub. No.: US 2012/0108120 A1
(43) Pub. Date: May 3, 2012

(54) EXTRUSION LAMINATE USEFUL IN INSULATION FACINGS AND TAPE BACKINGS

(75) Inventors: Michael Klauber, Simpsonville, SC (US); John Cullen, Appleton, WI (US); Michael Ream, Easton, PA (US)

(73) Assignee: INTERTAPE POLYMER CORP., Bradenton, FL (US)

(21) Appl. No.: 13/275,471

(22) Filed: Oct. 18, 2011

Related U.S. Application Data
(60) Provisional application No. 61/407,583, filed on Oct. 28, 2010.

(51) Int. Cl. B32B 27/06

(52) U.S. Cl. 442/1

(57) ABSTRACT

A facing or backing, that comprises a laminated film including an outside layer, a core layer, and an inside layer; a scrim, a laminating extrudate and a metal foil wherein at least the laminated film has an opacity and stiffness similar to paper and contains a fire retardant. In one embodiment, the structures are designed to replace the traditional ASJ (all service jacket) and FSK (foil scrim kraft) paper laminations that are used in insulation facings and HVAC tapes.

### CROSS-REFERENCE TO RELATED APPLICATIONS

This application claims the benefit of Provisional Application 61/407,583 filed Oct. 28, 2010.

### FIELD OF INVENTION

This invention relates to substrates that are useful as backings for tapes or as facings for insulation.

### SUMMARY OF THE INVENTION

In one embodiment, the structures are designed to replace the traditional ASJ (all service jacket) and FSK (foil scrim kraft) paper laminations that are used in insulation facings and HVAC tapes.

One embodiment of the invention is a structure such as a facing or backing that comprises a laminate (e.g., a coextrusion) of an outside layer, a core layer, and an inside layer; a scrim, a laminating extrudate or adhesive and a metal foil wherein the coextruded film is formed from an extruded film having opacity and stiffness similar to paper and contains a fire retardant. In one embodiment the laminate is a coextruded laminar film of HDPE and a fire retardant.

In another manifestation at least the outside layer of the laminate contains a white pigment (surface modifier, mineral filler, coloring additive) such as talc or titanium dioxide or a brown pigment. White pigments yield a structure that mimics a white paper whereas brown pigments mimic a Kraft paper.

In another manifestation the laminating adhesive contains a combination of LDPE, an acrylic acid copolymer, and a fire retardant that bonds the metal foil to the HDPE film.

In another manifestation both the outer and inner lamina forming the coextruded laminated film are formed from an extrudate of HDPE and a fire retardant.

In another manifestation the extrudate for at least the outside layer of the film contains a combination of HDPE, a white pigment and a fire retardant and yields a film having a stiffness comparable to paper. In another manifestation, the extrudate for the core layer contains HDPE, LDPE and a fire retardant. The LDPE in the core provides bulk as well as puncture resistance. it also makes the structure more flexible and gives the structure better cold weather flexibility.

In another manifestation the outside layer of the film contains a combination of HDPE, a brown pigment and a fire retardant and the extrudate yields a film having a stiffness comparable to Kraft paper.

In another manifestation the metal foil is aluminum foil.

In another manifestation the structure is a facing that comprises a coextruded laminate including an outside layer, a core layer, and an inside layer, a scrim, a laminate extrudate, and aluminum foil wherein the inside, core, and outside layers are extrudates of HDPE and a fire retardant, the outside layer additionally contains a white pigments such as talc or titanium dioxide or a brown pigment, the laminate extrudate contains LDPE and and adhesion promoter for adhering the HDPE film and the aluminum foil.

In another manifestation, the structure has properties suitable for use as a facing for insulation or backing for a HVAC tape.

Another manifestation is a tape having a facing in accordance with any of the manifestations described above.

Another manifestation is insulation having a facing in accordance with any of the manifestations described above.

### BRIEF DESCRIPTION OF THE DRAWING

FIG. 1 is an exploded view of a backing or facing in accordance with one embodiment of the invention.

### DETAILED DESCRIPTION

In accordance with one embodiment, the backing or facing is constructed using a three layer HDPE coextruded film. This film is selected to mimic the handling and supporting characteristics of paper based backings and facings. Other films may be used that similarly imitate the properties of a paper backing. Examples of such films include coextrusions of HDPE and LDPE, blends of HDPE with LDPE, films comprised mainly of LDPE. The film could also be BOPP (biaxially oriented polyproplyene) or BOPET (biaxially oriented PET). Typically, the coextruded film is about 0.5 to 4 mils thick. If BOPP or BOPET are used the films can be thinner.

The extruded film includes pigments to mimic the appearance of paper. The amount of the pigment is adjusted to provide the desired appearance as well as imparting and maintaining properties that mimic a paper structure. In one embodiment, the film contains 25% by weight talc in the outside layer of the extruded film (i.e., 8.33% of the total film). However, embodiments are also possible in which pigment is added to any one or all of the film layers and/or to the extrudates. It is estimated that the amount of the pigment may be about 0.5 to 30% of the outside lamina or about 0.15 to 10% by weight based on the total coextruded film.

While aluminum foil is a widely used metal foil, other foils that may be used include metallized BOPP or metallized BOPET to simulate the moisture barrier and appearance of foil. The foils are used in a thickness that is compatible with their use as a backing or facing. Typically, aluminum foil is used in a thickness of about 0.29 to 2 mils.

In one embodiment the flame retardant is a proprietary retardant sold under the tradename Ampacet. Other flame retardants may be selected from clays, modified clays, antimony oxide, antimony trioxide, arsenic, octadecanoic acid, aluminum salt, aluminum tristearate, lead oxide, 1H-isoindole-1,3(2H)-dione,2,2′-(1,2-ethanediyl)bis(4,5,6,7-tetrabromo) chlorinated paraffin, halogenated flame retardants, phosphorous based flame retardants, and combinations thereof. The amount of the flame retardant is adjusted to meet the appropriate standards for fire retardancy. The flame retardant is typically present in an amount of about 5 to 30% by weight for the total laminated film.

Useful scrims have about 3 to 5 ends per inch in the warp and/or weft directions.

One example of a laminate used in accordance with one embodiment of the invention is shown in the table below and comprises an extrusion laminate of a film (such as an HDPE film) with a premade scrim and aluminum or another metal foil. The structure of the HDPE film (or analogous film) contributes to both the appearance and the functionality of the laminate. The structure/formulation that is shown in the table below is one of a number of possible examples:

Coextruded Film Product Formulation

| | | Outside | Core | Inside | | | |
|---|---|---|---|---|---|---|---|
| % of total | | 25.0% | 50.0% | 25.0% | | | |
| Thickness (mills) | | 0.005 | 0.0010 | 0.005 | | | |
| Component | Resin or Additive | % in | % in | % in | % total | | Melt |
| Description | Grade Number | layer | layer | layer | in film | Density | Index |
| FR Concentrate | Ampacet 101199 | 15.0% | 15.0% | 15.0% | 15.0% | 1.88 | 20 |
| Talc Concentrate | Polifil ABC-4000- | 25.0% | | | 6.3% | 1.28 | 7 |
| | 445HD | | | | | | |
| HDPE | 9458 | 60.0% | 20.0% | 85.0% | 46.3% | 0.958 | 0.45 |
| LDPE | Dow 132i | | 65.0% | | 32.5% | 0.921 | 0.22 |
| | | 100.0% | 100.0% | 100.0% | 100.0% | | |

In the table, all percentages are weight percentages. In this embodiment the film is manufactured on a 3 layer blown film coextrusion line in the structure shown above. The addition of the flame retardant additive to all three layers (i.e., the outside, core and inside layers) of the film is designed to provide flame retardant properties to the film. However, it is expected that embodiments are also feasible in which the flame retardant is added to the outside layer and may not be necessary in one or both of the core and inside layers to provide the requisite flame retardant properties.

The purpose of using HDPE or an analogous or comparable polymer material is to give the film stiffness comparable to the paper it is designed to replace. A commercial talc containing additive (Polifil (ABC-4000-445HD)) is used to give the exposed surface of the outside layer of the film a paper-like appearance. The inside layer that is laminated to the foil may be corona treated or otherwise modified to enhance adhesion to the metal foil and/or to the extrudate used as the laminate adhesive. Other treatments to enhance adhesion to the foil could also be used as discussed later.

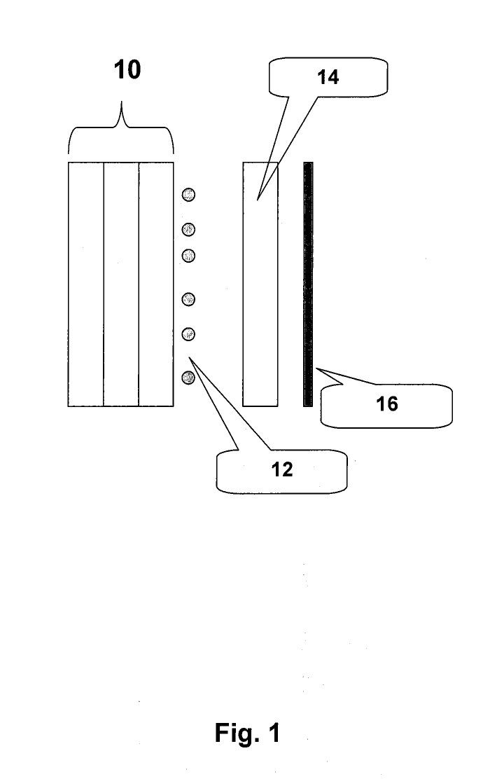

Other additives than talc can be used to create a paper-like surface. For example, a pigment may be added to one or more or all three layers to create the appearance of a white paper, or a colored paper, such as a brown to simulate unbleached kraft paper. This film was manufactured using conventional HDPE film extrusion conditions with melt temperatures between about 350° F. and 450° F. One such illustration is provided in the attached FIG. 1. It is desirable to produce a film with good opacity and that is essentially void free.

This film was extrusion laminated to a 0.000285 inch thick aluminum foil, with a scrim sandwiched between a laminating extrudate or adhesive and the film. One of the structures included a laminating extrudate of LDPE, an acrylic acid copolymer, and a fire retardant as shown in the table below, and had the following structure:
HDPE film/premade scrim/laminating extrudate/foil

In the laminating process, extrusion melt temperatures between about 515° F. and 550° F. were used in this example. The temperature was selected based on the mixture in the extrudate and on the amount of adhesion required between the film and the foil. In this non-limiting example, Primacor resin (an ethylene-acrylic acid copolymer) was used in the extrudate (EXL-0710-155) to provide a bond with the foil, and an LDPE resin was used to bond with the HDPE film. The extrudate contained 28% Primacor (ethylene-acrylic acid copolymer) resin (EEA), 62% LDPE and 10% Ampacet 101199 flame retardant. All percentages shown in the structure are weight percentages. The thickness of the laminating extrudate was controlled at approximately 0.8 mils, but it could have been thicker or thinner. Flame retardant additive was included in the extrudate to enhance the flame retardant capabilities of the entire structure in this example. This product is illustrated in FIG. 1 where the film 10, reinforcing scrim 12 and foil 16 are assembled with the laminating adhesive 14. The product that resulted from this lamination was approximately 62″ wide, and could be slit to different widths as required. This product was produced in a single pass on an extrusion coating/lamination line.

In the laminating adhesive, the ethylene-acrylic acid copolymer functions as an adhesion promoter. It promotes the adhesion to foil, to which polypropylene (PP) or PP would have a lower adhesion without the addition of the EEA In addition to LDPE and ethylene-acrylic acid copolymers, other laminating adhesives or extrudates that can be used include anhydride modified polymers and copolymers as adhesion promoters. The laminating adhesive is coated in an amount of about 12 to 72 g/cm².

In another example, the structure was prepared in a two pass lamination where the scrim was laminated to the HDPE film shown in the table in the first pass using an extrudate that contained 10 wt % Ampacet 101199 FR concentrate, 5 wt % of a 70% loaded TiO2 masterbatch, and the remainder LDPE. The second pass laminated the first pass structure to aluminum foil using the Primacor blend as (EXL-0710-155) shown above. The result was a structure that displayed more of a paper appearance because of the white pigment in the first pass adhesive. The total adhesive polymer thickness was approximately 0.0016″.

Having described the invention in detail and by reference to specific embodiments thereof, it will be apparent that variations and modifications are possible without departing from the spirit and scope of the following claims.

What is claimed is:

1. A structure, such as a facing or backing, that comprises a laminated film including an outside layer, a core layer, and an inside layer; a scrim, a laminating extrudate and a metal foil wherein at least the laminated film has an opacity and stiffness similar to paper and contains a fire retardant.

2. The structure of claim 1 wherein at least the outside layer is formed from an extrudate of HDPE and a fire retardant.

3. The structure of claim 2 wherein the extrudate for at least the outside layer contains a white pigment such as talc or titanium dioxide or a brown pigment.

4. The structure of claim 3 wherein the laminating extrudate contains a combination of LDPE, an acrylic acid copolymer, and a fire retardant.

5. The structure of claim 4 wherein both the outer and inner layers are formed from an extrudate of HDPE and a fire retardant.

6. The structure of claim 1 wherein at least the outside layer contains a combination of HDPE, a white pigment and a fire retardant and the film has a stiffness comparable to paper.

7. The structure of claim 1 wherein the core layer contains LDPE, HDPE, and a fire retardant.

8. The structure of claim 1 wherein the outside layer contains a combination of HDPE, a brown pigment and a fire retardant and the laminate has a stiffness comparable to kraft paper.

9. The structure of claim 1 wherein the metal foil is aluminum.

10. The structure of claim 1 that comprises a coextruded laminar film of an outside layer, a core layer, and an inside layer, a scrim, a laminating adhesive, and aluminum foil wherein the inside, core, and outside layers are extrudates of HDPE and a fire retardant, the outside layer additionally contains a white pigment or a brown pigment, and the laminating extrudate contains LDPE and an acrylic copolymer for adhering the HDPE film and the aluminum foil.

11. The structure of claim 10 suitable for use as a facing for insulation or a HVAC tape.

12. A tape having a backing in accordance with claim 1.

13. Insulation having a facing in accordance with claim 1.
